(19) United States
(12) Patent Application Publication
(10) Pub. No.: US 2023/0408679 A1
(43) Pub. Date: Dec. 21, 2023

(54) OCCUPANT DETERMINATION APPARATUS AND OCCUPANT DETERMINATION METHOD

(71) Applicant: Mitsubishi Electric Corporation, Tokyo (JP)

(72) Inventors: Taro KUMAGAI, Tokyo (JP); Takumi TAKEI, Tokyo (JP)

(73) Assignee: Mitsubishi Electric Corporation, Tokyo (JP)

(21) Appl. No.: 18/036,256

(22) PCT Filed: Jan. 29, 2021
(86) PCT No.: PCT/JP2021/003196

§ 371 Date: May 10, 2023

(51) Int. Cl. G01S 13/88; G01S 15/88

(52) U.S. Cl. CPC G01S 13/88; G01S 15/88

(57) ABSTRACT

It is an object to provide technology enabling an increase in accuracy of determination of an occupant in an interior of a vehicle. An occupant determination apparatus includes: a size detection unit to detect a size of a moving subject in the interior based on a reflected wave acquired by an acquisition unit; an occupant detection unit to detect whether there is an occupant in the interior based on the reflected wave acquired by the acquisition unit by a reflection of a wave; and a controller to determine whether there is a predetermined occupant in the interior based on a result of detection of the size detection unit and a result of detection of the occupant detection unit.

### TECHNICAL FIELD

The present disclosure relates to an occupant determination apparatus and an occupant determination method.

### BACKGROUND ART

In recent years, technology of detecting whether there is an infant in an interior of a vehicle using an image sensor and a radio frequency sensor has been proposed (e.g., Patent Document 1).

### PRIOR ART DOCUMENTS

### Patent Document

Patent Document 1: Japanese Patent Application Laid-Open No. 2019-123354

### SUMMARY

### Problem to be Solved by the Invention

Conventional technology, however, has a problem in that, when an infant does not appear in a video acquired from various sensors even though there is the infant in the interior of the vehicle, determination that there is the infant cannot be made, for example.

The present disclosure has been conceived in view of a problem as described above, and it is an object to provide technology enabling an increase in accuracy of determination of an occupant in an interior of a vehicle.

### Means to Solve the Problem

An occupant determination apparatus according to the present disclosure includes: an acquisition unit to acquire a reflected wave generated by a reflection of a wave being a radio wave or an ultrasound wave in an interior of a vehicle; a size detection unit to detect a size of a moving subject in the interior based on the reflected wave acquired by the acquisition unit; an occupant detection unit to detect whether there is an occupant in the interior based on the reflected wave acquired by the acquisition unit by the reflection of the wave; and a controller to determine whether there is a predetermined occupant in the interior based on a result of detection of the size detection unit and a result of detection of the occupant detection unit.

### Effects of the Invention

According to the present disclosure, whether there is the predetermined occupant in the interior is determined based on the result of detection of the size detection unit and the result of detection of the occupant detection unit, so that accuracy of determination of the occupant in the interior of the vehicle can be increased.

The objects, features, aspects and advantages of the present disclosure will become more apparent from the following detailed description and the accompanying drawings.

### BRIEF DESCRIPTION OF DRAWINGS

FIG. 1 is a block diagram showing a configuration of an occupant determination apparatus according to Embodiment 1.

FIG. 2 is a diagram for describing a size detection unit according to Embodiment 1.

FIG. 3 is a diagram for describing an occupant detection unit according to Embodiment 1.

FIG. 4 is a diagram for describing the occupant detection unit according to Embodiment 1.

FIG. 5 is a diagram for describing the occupant detection unit according to Embodiment 1.

FIG. 6 is a diagram for describing the occupant detection unit according to Embodiment 1.

FIG. 7 is a diagram for describing the occupant detection unit according to Embodiment 1.

FIG. 8 is a diagram for describing a position of an acquisition unit according to Embodiment 1.

FIG. 9 is a flowchart showing operation of the occupant determination apparatus according to Embodiment 1.

FIG. 10 is a block diagram showing a hardware configuration of an occupant determination apparatus according to a modification.

FIG. 11 is a block diagram showing a hardware configuration of an occupant determination apparatus according to a modification.

FIG. 12 is a block diagram showing a configuration of a server according to a modification.

FIG. 13 is a block diagram showing a configuration of a communication terminal according to a modification.

### DESCRIPTION OF EMBODIMENT

### Embodiment 1

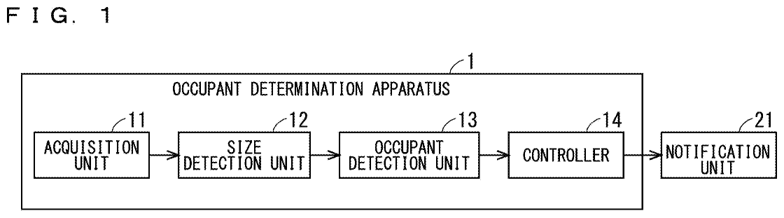

FIG. 1 is a block showing a configuration of an occupant determination apparatus 1 according to Embodiment 1. The occupant determination apparatus 1 in FIG. 1 includes an acquisition unit 11, a size detection unit 12, an occupant detection unit 13, and a controller 14.

The acquisition unit 11 acquires a reflected wave generated by a reflection of a wave in an interior of a vehicle. The wave of the acquisition unit 11 may be a radio wave, such as a millimeter wave, or may be an ultrasound wave, for example. The acquisition unit 11 may be a millimeter wave radar including a radar module having an array antenna to output and receive the wave, or may be an ultrasound wave radar equivalent to the millimeter wave radar, for example. While the acquisition unit 11 is described as a radar capable of outputting the wave in Embodiment 1, the acquisition unit 11 is not limited to that described in Embodiment 1.

<Acquisition Unit>

The acquisition unit 11 can detect, by acquiring reflected waves generated by one or more reflections of the wave from various angles, intensities of the reflected waves for various angles. In description made below, the angles from which the acquisition unit 11 acquires the reflected waves are referred to as “acquisition angles”.

<Size Detection Unit>

The size detection unit 12 performs first detection of detecting a size of a moving subject in the interior of the vehicle based on the reflected wave acquired by the acquisition unit 11. The moving subject includes a moving occupant, a moving load, and the like. A specific example of the size detection unit 12 will be described below.

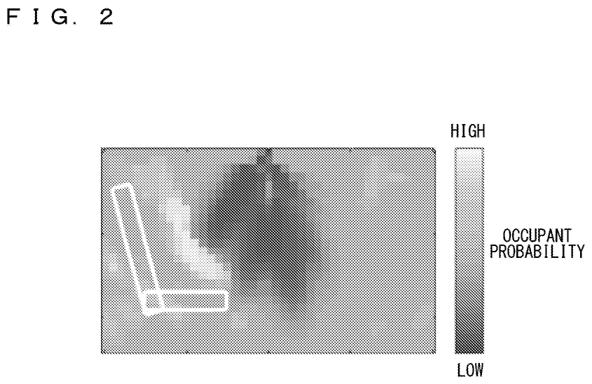

The size detection unit 12 extracts, from among the reflected waves acquired for various acquisition angles by the acquisition unit 11, reflected waves each having an intensity equal to or greater than a threshold, and acquires a distance between the acquisition unit 11 and the moving subject based on intensities of the reflected waves extracted for various acquisition angles. The threshold is herein set to approximately an intensity of the wave reflected once, for example. The size detection unit 12 generates a three-dimensional video from a viewpoint of the acquisition unit 11 based on the distance between the acquisition unit 11 and the moving subject acquired for various acquisition angles. The size detection unit 12 detects the size of the moving subject from a portion of the generated three-dimensional video, the portion having a high occupant probability, which is a probability of presence of an occupant. In FIG. 2, a cross section of a seat of the vehicle is schematically shown using two rectangles, and the portion having the high occupant probability is set to a portion along the seat.

According to the size detection unit 12 as described above, the size and the position of the moving subject can be detected when a motion of the moving subject is large. When the motion of the moving subject in the interior is small, however, it is difficult for the size detection unit 12 to detect the moving subject, and, even if the moving subject can be detected, it is difficult to distinguish whether the moving subject is an occupant, that is, whether the moving subject is a person or an object. Since the size detection unit 12 performs detection using the wave reflected once, a region out of reach of the wave is present as a blind spot region in detection performed by the size detection unit 12.

<Occupant Detection Unit>

The occupant detection unit 13 in FIG. 1 detects whether there is an occupant in the interior of the vehicle based on learning of the reflected wave (hereinafter also referred to as a “multiple times reflected wave”) acquired by the acquisition unit 11 by a plurality of reflections of the wave. A specific example of the occupant detection unit 13 will be described below.

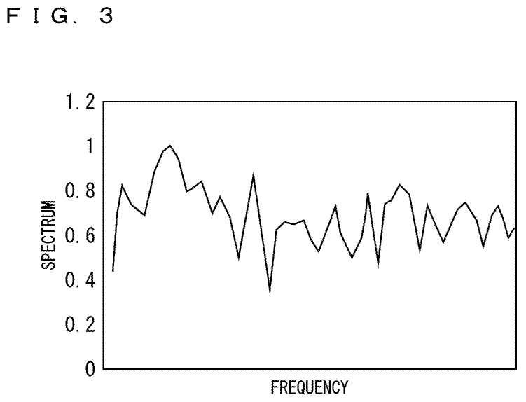

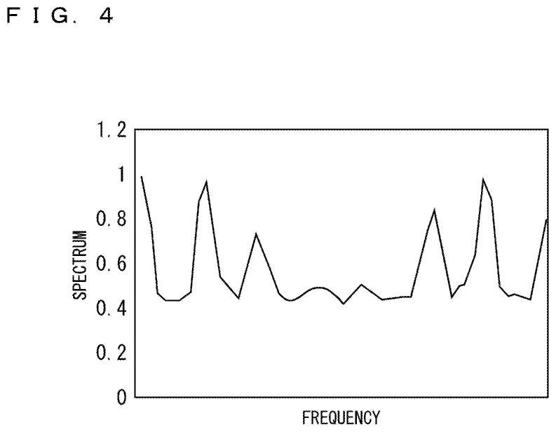

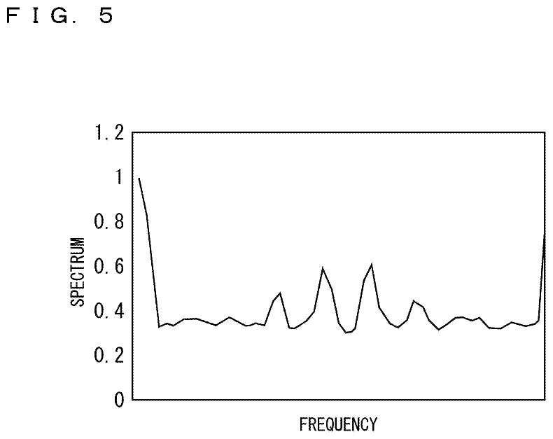

The occupant detection unit 13 acquires a frequency spectrum of the multiple times reflected wave. The frequency spectrum of the multiple times reflected wave includes a spectrum of the Doppler frequency and the like, and reflects various motions of the moving subject in the interior of the vehicle. FIGS. 3 to 5 are diagrams showing examples of the frequency spectrum of the multiple times reflected wave. The frequency spectrum in FIG. 3 reflects breathing and motions of arms and legs of an infant, the frequency spectrum in FIG. 4 reflects rocking of the vehicle, and the frequency spectrum in FIG. 5 reflects a vibration of a smartphone as the load. As described above, the frequency spectrum of the multiple times reflected wave varies depending on the moving subject.

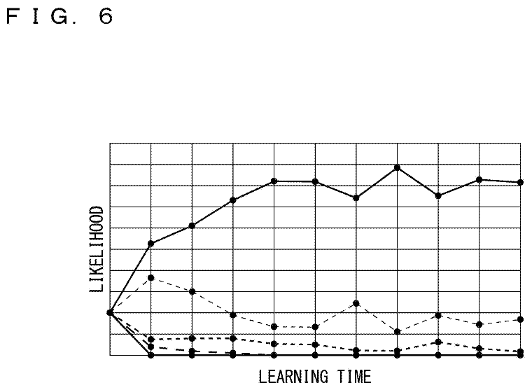

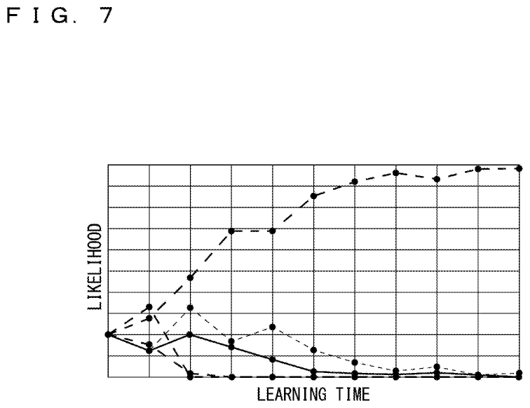

The occupant detection unit 13 thus detects whether there is the occupant in the interior of the vehicle based on learning of the frequency spectrum of the multiple times reflected wave. For example, machine learning is used for learning. FIGS. 6 and 7 are diagrams showing examples of a result of learning of the occupant detection unit 13. As a time or a frequency of learning of the frequency spectrum of the moving subject increases, likelihood that there is the infant in the interior increases in FIG. 6, and likelihood that there is the smartphone in the interior increases in FIG. 7.

According to the occupant detection unit 13 as described above, the multiple times reflected wave is used for detection, so that it is difficult to detect the size and the position of the moving subject. The occupant detection unit 13, however, can detect a motion of the occupant smaller than a motion of the occupant that can be detected by the size detection unit 12. The occupant detection unit 13 can also detect the occupant both in a detection region and in the blind spot region of the size detection unit 12. That is to say, the occupant detection unit 13 can detect whether there is the occupant at least in the blind spot region of the size detection unit 12 in the interior. As the blind spot region of the size detection unit 12, a region above a floor between a front seat and a back seat of the vehicle, a region above a rearward-facing child restraint, a region of a luggage space in a rear portion of the interior of the vehicle, and the like are contemplated. The occupant detection unit 13 is not limited to that described above, and may be configured to detect whether there is the occupant in the interior based on the reflected wave acquired by the acquisition unit 11 by one or more reflections of the wave.

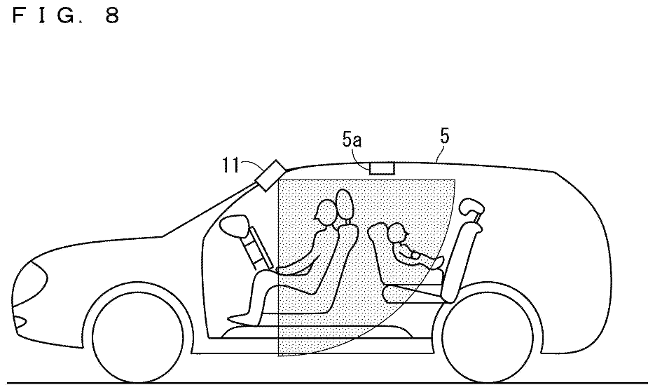

The acquisition unit 11 is herein preferably disposed in an upper portion of a front portion of the interior of the vehicle as illustrated in FIG. 8. The upper portion of the front portion of the interior of the vehicle includes an overhead console of the vehicle and an upper portion of a windshield of the vehicle, for example. According to such a configuration, the acquisition unit 11 can receive the reflected wave having reached a wide range of the interior, so that the blind spot region of the occupant detection unit 13 can be reduced.

As illustrated in FIG. 8, a direction of travel of the wave before the reflection output from the acquisition unit 11 is preferably set to avoid a protrusion 5a of a ceiling 5 of the interior of the vehicle, such as an openable window of a sunroof and a switch of the vehicle. According to such a configuration, the acquisition unit 11 can receive the reflected wave having reached the wide range of the interior, so that the blind spot region of the occupant detection unit 13 can be reduced. While the above-mentioned direction of travel is illustrated to be set to avoid the protrusion 5a in cross section of the vehicle in FIG. 8, the above-mentioned direction of travel may be set to avoid the protrusion 5a in plan view of the ceiling 5 of the vehicle, which is not illustrated.

<Controller>

The controller 14 in FIG. 1 determines whether there is a predetermined occupant in the interior based on a result of detection of the size detection unit 12 and a result of detection of the occupant detection unit 13. The predetermined occupant includes at least one of a healthy adult, an infant, and an assisted person, for example. A specific example of the controller 14 will be described below.

When it is determined that the size of the moving subject is equal to or greater than a threshold based on the result of detection of the size detection unit 12, the controller 14 determines that the moving subject is the healthy adult regardless of the result of detection of the occupant detection unit 13.

When it is determined that the size of the moving subject is smaller than the threshold based on the result of detection of the size detection unit 12, the controller 14 determines that the moving subject is an awake and moving infant or a moving load, such as a plastic bottle with water. In this case, the controller 14 determines that there is the moving infant in the interior when the occupant detection unit 13 detects the occupant in the interior, and determines that there is the moving load in the interior when the occupant detection unit 13 detects no occupant in the interior.

When the size detection unit 12 has detected a plurality of moving subjects, the controller 14 makes the above-mentioned determination for each of the plurality of moving subjects.

When the size detection unit 12 detects no moving subject, and the occupant detection unit 13 detects the occupant in the interior, the controller 14 determines that there is the infant or the assisted person. As a case where such determination is made, a case where there is the infant or the assisted person having a small motion due to sleep and the like in the detection region of the size detection unit 12, a case where there is the infant or the assisted person in the blind spot region of the size detection unit 12, and the like are contemplated.

When the size detection unit 12 detects no moving subject, and the occupant detection unit 13 detects no occupant in the interior, the controller 14 determines that there is no occupant in the interior.

A notification unit 21 relating to the vehicle notifies a user of the vehicle and the like using display, a sound, and the like, and notifies a communication terminal of the user of the vehicle and the like using wireless communication. While the occupant determination apparatus 1 according to Embodiment 1 does not include the notification unit 21, the occupant determination apparatus 1 may include the notification unit 21. The notification unit 21 may be disposed in the vehicle, or may not be disposed in the vehicle.

The controller 14 controls a notification of the notification unit 21 based on the above-mentioned result of determination. A timing of the notification of the notification unit 21 includes a timing of door lock of the vehicle, a timing after an elapse of a predetermined time since the door lock of the vehicle, and the like.

The controller 14 performs control to turn off the notification of the notification unit 21 when it is determined that the moving subject includes the healthy adult, when it is determined that there is the moving load in the interior, or when it is determined that there is no occupant in the interior, for example. The controller 14 performs control to turn on the notification of the notification unit 21 when it is determined that there is only at least one of the infant and the assisted person in the interior, for example.

<Operation>

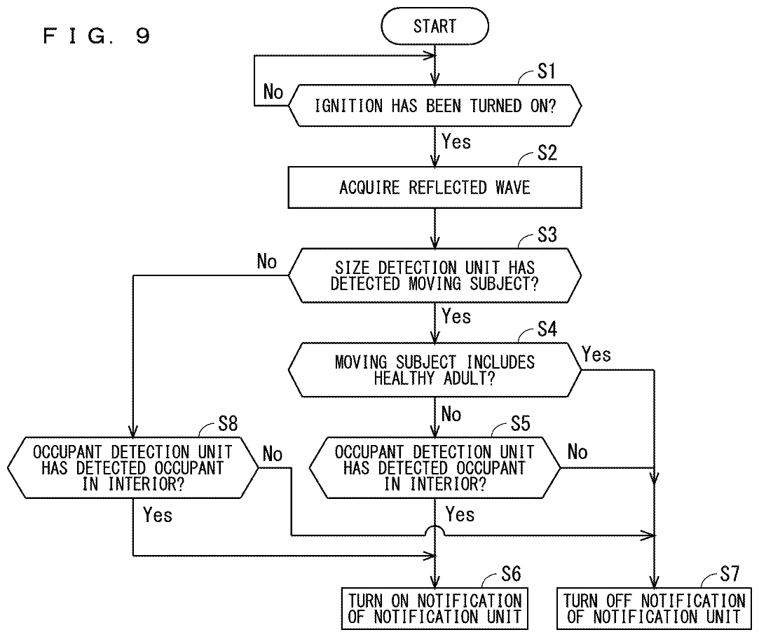

FIG. 9 is a flowchart showing operation of the occupant determination apparatus 1 according to Embodiment 1.

First, in step S1, whether an ignition of the vehicle has been turned on is determined. Processing proceeds to step S2 when it is determined that the ignition has been turned on, and processing in step S1 is performed again when it is not determined that the ignition has been turned on.

In step S2, the acquisition unit 11 acquires the reflected wave.

In step S3, the controller 14 determines whether the size detection unit 12 has detected the moving subject. Processing proceeds to step S4 when it is determined that the size detection unit 12 has detected the moving subject, and proceeds to step S8 when it is not determined that the size detection unit 12 has detected the moving subject.

In step S4, the controller 14 determines whether the moving subject includes the healthy adult based on the result of detection of the size detection unit 12. Processing proceeds to step S7 when it is determined that the moving subject includes the healthy adult, and proceeds to step S5 when it is not determined that the moving subject includes the healthy adult.

In step S5, the controller 14 determines whether the occupant detection unit 13 has detected the occupant in the interior. When the occupant detection unit 13 has detected the occupant in the interior, it is determined that there is the moving infant in the interior, and processing proceeds to step S6. When the occupant in the interior has not been detected, it is determined that there is the moving load in the interior, and processing proceeds to step S7.

In step S6, the controller 14 performs control to turn on the notification of the notification unit 21. Operation in FIG. 9 then ends.

In step S7, the controller 14 performs control to turn off the notification of the notification unit 21. Operation in FIG. 9 then ends.

In step S8, the controller 14 determines whether the occupant detection unit 13 has detected the occupant in the interior. When the occupant detection unit 13 has detected the occupant in the interior, it is determined that there is the infant or the assisted person in the detection region or the blind spot region of the size detection unit 12, and processing proceeds to step S6. When the occupant in the interior has not been detected, it is determined that there is no occupant in the interior, and processing proceeds to step S7.

### Summary of Embodiment 1

The occupant determination apparatus 1 according to Embodiment 1 as described above includes: the size detection unit to detect the size of the moving subject in the interior based on the reflected wave acquired by the acquisition unit 11; the occupant detection unit 13 to detect whether there is the occupant in the interior based on learning of the reflected wave acquired by the acquisition unit 11 by the plurality of reflections of the wave; and the controller 14 to determine whether there is the predetermined occupant in the interior based on the result of detection of the size detection unit 12 and the result of detection of the occupant detection unit 13. According to such a configuration, the occupant detection unit 13 can detect the occupant in the blind spot region of the size detection unit 12, so that accuracy of determination on whether there is the occupant can be increased. By combining the result of detection of the size detection unit 12 and the result of detection of the occupant detection unit 13, a type of the occupant can be determined.

In Embodiment 1, the controller 14 performs control to turn off the notification of the notification unit 21 when determining that the moving subject includes the healthy adult based on the result of detection of the size detection unit 12 regardless of the result of detection of the occupant detection unit 13. Furthermore, the controller 14 performs control to turn off the notification of the notification unit 21 when it is determined that the moving subject is the infant or the load based on the result of detection of the size detection unit 12 and the occupant detection unit 13 detects no occupant in the interior. According to such a configuration, an unnecessary notification can be suppressed.

### Other Modifications

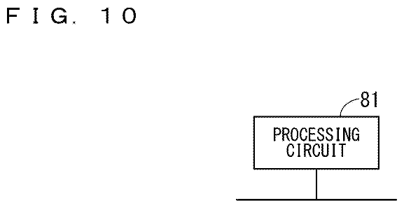

The acquisition unit 11, the size detection unit 12, the occupant detection unit 13, and the controller 14 in FIG. 1 described above are referred to as “the acquisition unit 11 and the like” below. The acquisition unit 11 and the like are achieved by a processing circuit 81 shown in FIG. 10. That is to say, the processing circuit 81 includes: the acquisition unit 11 to acquire the reflected wave generated by the reflection of the wave being the radio wave or the ultrasound wave in the interior of the vehicle; the size detection unit 12 to detect the size of the moving subject in the interior based on the reflected wave acquired by the acquisition unit 11; the occupant detection unit 13 to detect whether there is the occupant in the interior based on the reflected wave acquired by the acquisition unit 11 by the reflection of the wave; and the controller 14 to determine whether there is the predetermined occupant in the interior based on the result of detection of the size detection unit 12 and the result of detection of the occupant detection unit 13. Dedicated hardware may be applied to the processing circuit 81, or a processor to execute a program stored in a memory may be applied to the processing circuit 81. The processor corresponds to a central processing unit, a processing unit, an arithmetic unit, a microprocessor, a microcomputer, a digital signal processor (DSP), and the like, for example.

When the processing circuit 81 is the dedicated hardware, the processing circuit 81 corresponds to a single circuit, a composite circuit, a programmed processor, a parallel programmed processor, an application specific integrated circuit (ASIC), a field programmable gate array (FPGA), and a combination thereof, for example. The functions of the components such as the acquisition unit 11 and the like may be achieved by distributed processing circuits, or may collectively be achieved by a single processing circuit.

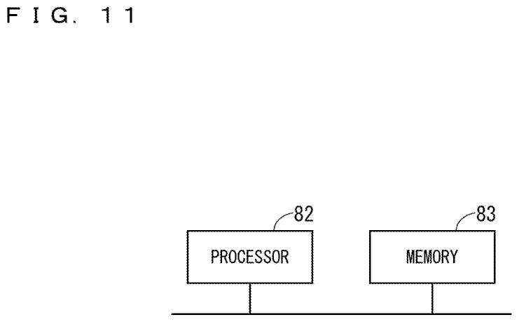

When the processing circuit 81 is the processor, the functions of the acquisition unit 11 and the like are achieved by combination with software and the like. The software and the like correspond to software, firmware, or software and firmware, for example. The software and the like are described as the program, and stored in the memory. As shown in FIG. 11, a processor 82 applied to the processing circuit 81 reads and executes the program stored in a memory 83 to achieve the functions of the components. That is to say, the occupant determination apparatus 1 includes the memory 83 to store the program which, when executed by the processing circuit 81, results in performance of steps including: acquiring the reflected wave generated by the reflection of the wave being the radio wave or the ultrasound wave in the interior of the vehicle; performing the first detection of detecting the size of the moving subject in the interior based on the acquired reflected wave; performing second detection of detecting whether there is the occupant in the interior based on the reflected wave acquired by the reflection of the wave; and determining whether there is the predetermined occupant in the interior based on a result of the first detection and a result of the second detection. In other words, it can be said that the program causes a computer to execute procedures or methods of the acquisition unit 11 and the like. The memory 83 herein may be, for example, a nonvolatile or volatile semiconductor memory, such as a random access memory (RAM), a read only memory (ROM), a flash memory, an erasable programmable read only memory (EPROM), and an electrically erasable programmable read only memory (EEPROM), a hard disk drive (HDD), a magnetic disk, a flexible disk, an optical disc, a compact disc, a mini disc, a digital versatile disc (DVD), a drive device thereof, and the like or any storage medium to be used in the future.

A configuration in which the functions of the acquisition unit 11 and the like are achieved by the hardware or by the software and the like is described above. The configuration, however, is not limited to this configuration, and one or more of the acquisition unit 11 and the like may be achieved by the dedicated hardware, and the other one or more of the acquisition unit 11 and the like may be achieved by the software and the like. For example, the function of the acquisition unit 11 can be achieved by the processing circuit 81 as the dedicated hardware, an interface, a receiver, and the like, and the functions of the other components can be achieved by the processing circuit 81 as the processor 82 reading and executing the program stored in the memory 83.

As described above, the processing circuit 81 can achieve the above-mentioned functions by hardware, software and the like, or a combination thereof.

The occupant determination apparatus 1 described above is applicable to an occupant determination system configured as a system by combining a vehicle device, such as a portable navigation device (PND), a navigation device, and a driver monitoring system (DMS), a communication terminal including a mobile terminal, such as a mobile phone, a smartphone, and a tablet, a function of an application installed on at least one of the vehicle device and the communication terminal, and a server as appropriate. In this case, the functions or the components of the occupant determination apparatus 1 described above may be distributed among instruments constituting the system, or may be concentrated on any of the instruments.

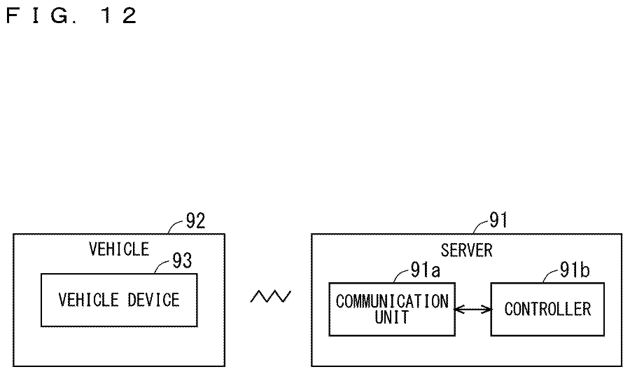

FIG. 12 is a block diagram showing a configuration of a server 91 according to a modification. The server 91 in FIG. 12 includes a communication unit 91a and a controller 91b, and can wirelessly communicate with a vehicle device 93, such as a DMS device, of a vehicle 92.

The communication unit 91a as the acquisition unit wirelessly communicates with the vehicle device 93 to receive information on the reflected wave acquired by the vehicle device 93.

The controller 91b has similar functions to the size detection unit 12, the occupant detection unit 13, and the controller 14 in FIG. 1 by an unillustrated processor and the like of the server 91 executing a program stored in an unillustrated memory of the server 91. That is to say, the controller 91b performs the first detection and the second detection, and determines whether there is the predetermined occupant in the interior of the vehicle 92 based on the result of the first detection and the result of the second detection. The communication unit 91a transmits a result of determination of the controller 91b to the vehicle device 93. According to the server 91 having such a configuration, a similar effect to that obtained by the occupant determination apparatus 1 described in Embodiment 1 can be obtained.

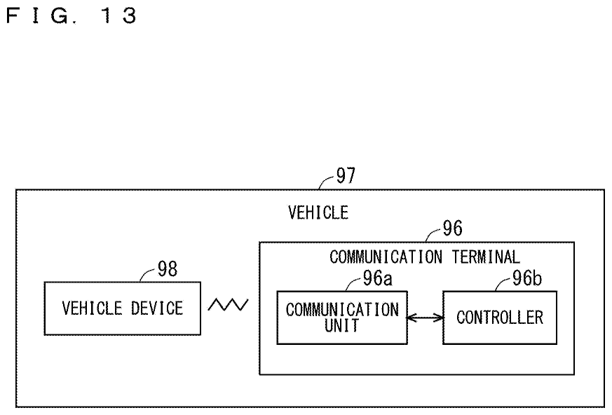

FIG. 13 is a block diagram showing a configuration of a communication terminal 96 according to a modification. The communication terminal 96 in FIG. 13 includes a communication unit 96a similar to the communication unit 91a and a controller 96b similar to the controller 91b, and can wirelessly communicate with a vehicle device 98 of a vehicle 97. A mobile terminal, such as a mobile phone, a smartphone, and a tablet, carried by a 5 driver of the vehicle 97 is applied to the communication terminal 96, for example. According to the communication terminal 96 having such a configuration, a similar effect to that obtained by the occupant determination apparatus 1 described in Embodiment 1 can be obtained.

The embodiment can be modified or omitted as appropriate. The foregoing description is in all aspects illustrative and not restrictive. It is understood that numerous unillustrated modifications can be devised.

### EXPLANATION OF REFERENCE SIGNS

1 occupant determination apparatus, 5 ceiling, 5a protrusion, 11 acquisition unit, 12 size detection unit, 13 occupant detection unit, 14 controller, 21 notification unit.

1. An occupant determination apparatus comprising:
acquisition circuitry to acquire a reflected wave generated by a reflection of a wave being a radio wave or an ultrasound wave in an interior of a vehicle;
a size detector to detect a size of a moving subject in the interior based on the reflected wave acquired by the acquisition circuitry;
an occupant detector to detect whether there is an occupant in the interior based on the reflected wave acquired by the acquisition circuitry by the reflection of the wave; and
a controller to determine whether there is a predetermined occupant in the interior based on a result of detection of the size detector and a result of detection of the occupant detector, wherein
the controller performs control to turn off a notification of notification circuitry relating to the vehicle when it is determined that the moving subject is an infant or a load based on the result of detection of the size detector and the occupant detector detects no occupant in the interior.

2. The occupant determination apparatus according to claim 1, wherein
the acquisition circuitry is disposed in an upper portion of a front portion of the interior of the vehicle.

3. The occupant determination apparatus according to claim 2, wherein
the acquisition circuitry is capable of outputting the wave, and
a direction of travel of the wave before the reflection output from the acquisition circuitry is set to avoid a protrusion of a ceiling of the interior.

4. The occupant determination apparatus according to claim 1, wherein
the controller performs control to turn off a notification of notification circuitry relating to the vehicle when determining that the moving subject includes a healthy adult based on the result of detection of the size detector regardless of the result of detection of the occupant detector.

5. (canceled)

6. An occupant determination apparatus comprising:
acquisition circuitry to acquire a reflected wave generated by a reflection of a wave being a radio wave or an ultrasound wave in an interior of a vehicle;
a size detector to detect a size of a moving subject in the interior based on the reflected wave acquired by the acquisition circuitry;
an occupant detector to detect whether there is an occupant in the interior based on the reflected wave acquired by the acquisition circuitry by the reflection of the wave; and
a controller to determine whether there is a predetermined occupant in the interior based on a result of detection of the size detector and a result of detection of the occupant detector, wherein
the occupant detector detects whether there is the occupant at least in a blind spot region of the size detector in the interior.

7. The occupant determination apparatus according to claim 1, wherein
the occupant detector detects whether there is the occupant in the interior based on learning of the reflected wave acquired by the acquisition circuitry by a plurality of reflections of the wave.

8. An occupant determination method comprising:
acquiring a reflected wave generated by a reflection of a wave being a radio wave or an ultrasound wave in an interior of a vehicle;
performing first detection of detecting a size of a moving subject in the interior based on the acquired reflected wave;
performing second detection of detecting whether there is an occupant in the interior based on the reflected wave acquired by the reflection of the wave;
determining whether there is a predetermined occupant in the interior based on a result of the first detection and a result of the second detection; and
performing control to turn off a notification of notification circuitry relating to the vehicle when it is determined that the moving subject is an infant or a load based on the result of the first detection and no occupant in the interior is detected in the second detection.
